(19) United States
(12) Patent Application Publication
(10) Pub. No.: US 2019/0079998 A1
(43) Pub. Date: Mar. 14, 2019

(54) BLOCKCHAIN DATA-PROCESSING ENGINE

(71) Applicant: Thomas Jay Rush, Gladwyne, PA (US)

(72) Inventor: Thomas Jay Rush, Gladwyne, PA (US)

(21) Appl. No.: 15/769,086

(22) PCT Filed: Jan. 25, 2018
(86) PCT No.: PCT/US2018/015145

§ 371 Date: Apr. 18, 2018

Related U.S. Application Data
(60) Provisional application No. 62/452,711, filed on Jan. 31, 2017.
(60) Provisional application No. 62/528,740, filed on Jul. 5, 2017.

(51) Int. Cl. G06F 17/30; H04L 9/06

(52) U.S. Cl. CPC G06F 17/30699; G06F 17/30687; H04L 2209/38; G06F 17/30185; H04L 9/0643

(57) ABSTRACT

In certain embodiments, for a blockchain such as the Ethereum blockchain, a data-processing engine maintains an accounts database having bloom filters that identify accounts that might have data in different portions of the blockchain, a blocks database that stores optimized versions of one or more (and possibly all of) the blocks in the blockchain, and a transaction-location database that stores a list of transaction locations for each of one or more accounts of interest (AOIs) supported by the engine. The engine uses the accounts and blocks databases to perform system-wide analyses quickly. The engine uses the transaction-location and blocks databases to generate reports for the AOIs quickly. The engine uses the accounts and blocks databases to generate, for the transaction-location database, a new transaction-location list for a new AOI quickly and without requiring a lot of memory.

### CROSS-REFERENCE TO RELATED APPLICATIONS

This application claims the benefit of the filing date of U.S. Provisional Patent Application No. 62/452,711, filed on Jan. 31, 2017 as Attorney Matter No. 1341.001PROV (“the '711 provisional application”), and U.S. Provisional Patent Application No. 62/528,740, filed on Jul. 5, 2017 as Attorney Matter No. 1341.001PROV2 (“the '740 provisional application”), the teachings of both of which are incorporated herein by reference in their entirety.

### BACKGROUND

### Field of the Invention

The present invention relates generally to blockchain-based systems, and more particularly, but not exclusively, to an engine for processing data from an arbitrarily large blockchain in a decentralized, compute/memory-limited manner.

### Description of the Related Art

This section introduces aspects that may help facilitate a better understanding of the invention. Accordingly, the statements of this section are to be read in this light and are not to be understood as admissions about what is prior art or what is not prior art.

Following the global financial crisis of 2008, which was considered by many economists to have been the worst financial crisis since the Great Depression of the 1930s, blockchain technology began to emerge as a method for removing the need for a centralized “trusted” authority from the process of wealth exchange. Many people and organizations are placing bets on how blockchains will revolutionize the way transactions are executed in the future.

At a minimum, blockchains provide a distributed/decentralized, consensus-driven, secure/immutable method for maintaining a ledger of transactions. In the context of a blockchain, “ledger of transactions” means an accounting ledger, each transaction in the ledger consisting of a spender (from), a recipient (to), a timestamp, and a value. “Distributed” in this context means that each participant's computer maintains his/her own identical copy of this ledger. “Consensus-driven” refers to the fact that a majority of participants, prior to writing to the ledger, must agree on what will be written. And finally, “immutable” refers to the fact that, once a transaction is written, it is all but impossible for a single participant (or group of participants that is smaller than a simple majority) to alter the ledger. Many expect the world to change in significant ways with the existence of a single unalterable, transparent, globally accessible, and validated version of the history of the world's financial and computing transactions.

At the heart of this system is data, and one of the great promises of blockchains, if it can be realized, is that each participant will have access to their own data. However, while accessible, this data is not as easily accessible as it should be. Nor is the data presented in as rich a format or with as deep a context as it could be. Nor is the data retrievable from blockchains in a reasonable timeframe, in current implementations, by systems with consumer-grade memory and/or computing resource limitations.

Blockchains store lists of transactions. These transactions are included in a block in a time-ordered basis. The accounts that initiate or receive transactions are stored on the blockchain, but not in an easily-accessible manner. This implies that building lists of transactions, given a particular account or a collection of accounts, is time consuming and difficult. This difficulty is exacerbated by the fact that the receiving account of certain transactions called an “internal transaction” may be a “smart contract,” which may further initiate transactions to other accounts or other smart contracts, in a nested manner.

Obtaining a list of these “internal transactions,” particularly those incoming to a particular account is an onerous process. One method of obtaining per-account lists of transactions is to index all the transactions by account. However, this imposes too high a burden on most reasonable end-user computing platforms in terms of storage requirements and processing time.

As an example, as of this writing, the central Ethereum blockchain contains some twenty-one million unique accounts (aka addresses) (out of a possible 2¹⁶⁰) and nearly five million blocks (see https://etherscan.io/). The size of the Ethereum blockchain increases by roughly four blocks every minute. However, while there is certainly a place in the blockchain ecosystem for powerful blockchain-processing nodes with Terabytes of memory and Petaflops of computing power that can work directly with such a large and complex data structure, there is also a heretofore unaddressed need for a way that individuals or small/mid-size organizations, interested in tracking a subset of those accounts, can do so on computer systems with reasonable computing/memory resources, in a decentralized manner.

A blockchain also contains much more information than a typical user may be interested in. Most people are interested in their own account data or those of their companies, rather than blocks, hashes, and mining data. This limited interest extends to both participants in, and purveyors of, smart contracts in Ethereum systems, as well as regular users of any of the related alt-coin currencies with their own accounts.

Existing blockchains utilize bloom filters for various reasons. In the Ethereum blockchain, for example, bloom filters are used in support of a publication/subscription (pub/sub) model of delivering notifications of triggered events to distributed applications. In that application, bloom filters are used to identify some of the accounts and other data involved in (or created during) the production of log entries. The Ethereum blockchain stores bloom filters for transactions that produced one or more log entries. These transaction-level bloom filters are then “rolled-up” to the block level. These “node-generated” bloom filters, while useful for some applications, take up quite a bit of memory.

The primary component of a blockchain network is the node or client. A blockchain node is a computer running a piece of networking software that runs identically and simultaneously on many computers at the same time. Blockchain nodes continually broadcast transactions to other nodes on the blockchain network and listen for transactions from other nodes. Competing with each other to be the first to identify a suitably difficult-to-find stochastically-generated solution to a cryptographic puzzle, the winning node constructs a block (using a recent collection of transactions) and, once consensus is reached with a majority of the other nodes, the winning node is rewarded with a newly created “coin” or “coins” of then-current value of the digital currency of the blockchain being processed.

The winner of the block additionally receives the accumulated transaction costs of the approved transactions. These costs are called “gas” in the Ethereum context.

It is this potential return on investment of a node's computing resources (e.g., block reward+gas) that incentivizes participants to both continue to participate and participate honestly. Note that a dishonest action is assumed to lessen the value of any previously accumulated rewards, and therefore dishonesty becomes increasingly less likely as the value of the digital currency increases.

In addition to providing “accounting services” in the form of block creation, each node provides an interface to its own copy of the blockchain data. This interface is provided either through RPC (remote procedure calls) or IPC (inter-process communication), each of which allows other software components to retrieve data from the blockchain.

However, these interfaces, in their current manifestation, expose the blockchain's data at a level that may be too close to the internal workings of the blockchain. This makes it difficult for users of the system to effectively process the received data from these interfaces. The RPC interface furthermore delivers this inadequate data in a piece-meal fashion. The meaning of particular portions of the data is dependent on the contents of other portions, requiring multiple calls through the interface to fully determine the validity and full meaning of each transaction.

The node's communication interfaces provide functionality for retrieving blocks, transactions, receipts, traces, account balances, and other highly-specific data such as mining information, block and transaction hashes, and, importantly, the ability to create, sign, and initiate transactions. These latter functionalities might not be of interest to end users who are primarily concerned with retrieving only blocks, transactions, receipts, traces, and logs.

Thus, a need exists for users, including systems architects, software developers, and simple non-technical end users with individual accounts, who are not interested in blockchain-specific formats, but rather in data customized and optimized for their particular use, to obtain fast, efficient, decentralized, and customized per-account access to a richer and more useful set of validated-blockchain data using computers (e.g., smartphones and laptops) with reasonably-bounded compute/memory resources.

### BRIEF DESCRIPTION OF THE DRAWINGS

Embodiments of the invention will become more fully apparent from the following detailed description, the appended claims, and the accompanying drawings in which like reference numerals identify similar or identical elements.

FIG. 1 is a block diagram of a blockchain-processing system comprising a blockchain data-processing (BDP) engine configured to process data in an Ethereum blockchain, according to one embodiment of the present invention;

FIG. 2 is a flow diagram of the processing performed by the BDP engine of FIG. 1 to generate a report for a specified account of interest (AOI) in response to a received report request;

FIG. 3 is a flow diagram of the processing performed by the BDP engine of FIG. 1 to update the transaction-location database of FIG. 1 when a new AOI is received; and

FIG. 4 is a flow diagram of the processing performed by the BDP engine of FIG. 1 to update the accounts database of FIG. 1 for a block retrieved from the blockchain of FIG. 1.

### DETAILED DESCRIPTION

Detailed illustrative embodiments of the present invention are disclosed herein. However, specific structural and functional details disclosed herein are merely representative for purposes of describing example embodiments of the present invention. The present invention may be embodied in many alternate forms and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the,” are intended to include the plural forms as well, unless the context clearly indicates otherwise. It further will be understood that the terms “comprises,” “comprising,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

While this invention applies to a wide variety of alternative digital currencies, the following description will be provided in the context of the Ethereum digital currency. One skilled in the art will recognize that this invention may be readily applied to other suitable digital currencies.

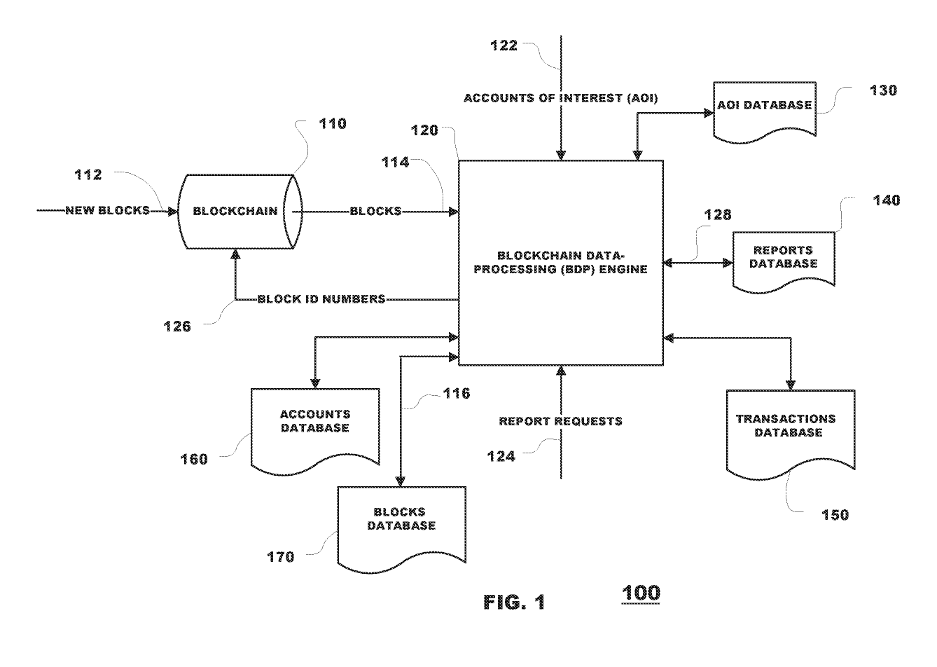

FIG. 1 is a block diagram of a blockchain data-processing (BDP) system 100 comprising a BDP engine 120 configured to process data stored in an Ethereum blockchain 110, according to one embodiment of the present invention. The BDP engine 120 provides a programming interface to blockchain data that enables quick, iterative, experimental exploration of that data. The BDP engine 120 can be designed to support many different functions including, but not limited to, smart contract monitoring, usage investigations, generation of databases for use in user-interface websites, and report generation.

The Ethereum blockchain 110 is a large data structure composed of many blocks that are cryptographically related/linked/chained to each other. The Ethereum blockchain 110 is described in Dr. Gavin Wood, “Ethereum: A Secure Decentralised Generalised Transaction Ledger,” EIP-150 REVISION (759dccd—2017 Aug. 7) (https://ethereum.github.io/yellowpaper/paper.pdf, accessed Dec. 10, 2017) (herein the “Yellow Paper”), the teachings of which are incorporated herein by reference in their entirety. The Ethereum blockchain 110 is stored in a decentralized Ethereum network (not shown in FIG. 1) that includes multiple nodes, each of which maintains an identical copy of the blockchain 110. The blockchain 110 is generated by starting with a common seed/genesis block and adding other consensus-validated blocks to the chain. Each block in the Ethereum blockchain 110 is sequentially assigned a unique, incremented 8-byte block identification (ID) number, and each account in the Ethereum blockchain 110 is assigned a unique 20-byte account ID number.

Each block in the blockchain 110 contains data associated with one or more transactions, where each transaction may involve one or more traces, and each trace may involve one or more accounts. For the Ethereum blockchain 110, a node in the Ethereum network can generate traces on demand for the BDP engine 120. To retrieve data associated with a particular account from a given block, the BDP engine 120 can process the block to identify each transaction and, for each transaction, the BDP engine 120 can analyze the one or more traces to determine whether the account is involved in that transaction.

The BDP engine 120 of FIG. 1, which can be, but does not have to be, implemented at one of the nodes of the Ethereum network, generates and maintains a number of different databases that provide faster and easier access to blockchain data than would otherwise be available by directly accessing the blockchain 110 without the benefit of those databases. To support its different functions, the BDP engine 120 maintains the following databases:
AOI database 130 which stores a list of the account ID numbers for the one or more accounts of interest (AOIs) 122 currently supported by the BDP engine 120;
Reports database 140 which stores reports 128 previously generated by the BDP engine 120 for the AOIs 122;
Transaction-location database 150 which stores, for each AOI 122 currently supported by the BDP engine 120, a transaction-location list containing the location in the blockchain 110 of each transaction for that AOI;
Accounts database 160 which stores bloom filters that very efficiently represent those accounts having data stored in different portions of the blockchain 110; and
Blocks database 170 which stores optimized, binary versions 116 of one or more (and possibly all) of the blocks 114 in the blockchain 110.

In one implementation, the location of each transaction is represented in the transaction-location database 150 by a numeric tuple consisting of the following parameters:
A 64-bit blockNumber identifying the block ID number of the block in the blockchain 110 containing the transaction;
A 64-bit transactionIndex identifying the location of the transaction within the block 114; and
A 64-bit traceID identifying an index into an array of calls made from within an “internal” (i.e., smart-contract) transaction.
   For “external” transactions, the traceID is ‘0’. In another implementation, each tuple in the transaction-location database 150 includes only the blockNumber and the transactionIndex. In that case, the BDP engine 120 would need to analyze the traces for each transaction in order to identify the traceID for each transaction of interest.

When the BDP engine 120 is initially provisioned, the BDP engine 120 processes the blocks 114 in the blockchain 110 in order starting from the very first block. As described in further detail below, at every block 114, the BDP engine 120 updates (i) the accounts database 160 for any accounts having one or more transactions in the block, (ii) the transaction-location database 150 for each transaction in the block associated with any of the AOIs 122, and (iii) possibly the blocks database 170.

In some implementations (for example, if the BDP engine 120 is to support large-scale, blockchain-wide data analysis), the BDP engine 120 stores an optimized, binary version 116 of each block 114 in the blocks database 170. In that case, if the BDP engine 120 needs data that is included in the optimized data in the blocks database 170, then the BDP engine 120 can retrieve that data from the blocks database 170 without having to go back to the blockchain 110. As such, the BDP engine 120 may never need to process any block 114 more than once.

In another possible implementation, if the block 114 has at least one transaction for at least one AOI 122, then the BDP engine 120 stores the optimized, binary version 116 in the blocks database 170. Otherwise, the BDP engine 120 discards the block 114 after updating the accounts database 160 and the transaction-location database 150 without updating the blocks database 170. In that case, if the BDP engine 120 needs data from a block that is not represented in the blocks database 170, then the BDP engine 120 will have to retrieve that block 114 from the blockchain 110.

In general, the decision about whether or not to store an optimized, binary version 116 of a blockchain block 114 in the blocks database 170 involves a tradeoff between storage space and data access speed. Storing data in the blocks database 170 increases the access speed for that data, but at the cost of additional storage space. Minimizing storage space helps to enable full decentralization by limiting the hardware requirements involved in implementing each BDP engine 120. In any case, if the BDP engine 120 needs data that is not otherwise included in the blocks database 170, then the BDP engine 120 will have to retrieve that data from the blockchain 110.

If and when the BDP engine 120 has sequentially processed all of the existing blocks in the blockchain 112, from then on, the BDP engine 120 needs to process the new blocks 112 as they get added periodically to the blockchain 110 to update the databases 150, 160, and 170 as appropriate.

As described further below, when a new AOI 122 gets added to the list of accounts to be handled by the BDP engine 120, the BDP engine 120 needs to generate a transaction-location list for that new AOI 122. To do that, the BDP engine 120 needs access to all of the transactions for that new AOI 122 in the blockchain 110. If any of those transactions are represented in the optimized, binary blocks 116 currently stored in the blocks database 170, then the BDP engine 120 retrieves those transactions from the blocks database 170. If any of those transactions are not represented in the blocks database 170, then the BDP engine 120 has to retrieve the corresponding blocks 114 from the blockchain 110. Note that, in that case, the BDP engine 120 will then store an optimized, binary version 116 of each such retrieved block 114 in the blocks database 170.

Note that, if a newly provisioned BDP engine 120 is added to a network of existing, identical instances of the BDP engines 120 for the Ethereum blockchain 120, rather than having to create each database from scratch, the new BDP engine 120 can get copies of existing databases from one or more other instances of the BDP engine 120. In that case, the new BDP engine 120 will be able to start its sequential block processing with the periodically added new blocks 112. Such a network of BDP engines 120 would technically not be fully decentralized since each BDP engine 120 would not be independent of all other BDP engines in the network. In a fully decentralized network, each BDP engine 120 would independently generate all of its databases from scratch. Note that, although the accounts database 160 and (possibly) the blocks database 170 from another BDP engine 120 will be identical to those databases for the new BDP engine 120, the contents of the transaction-location database 150 will be the same only for AOIs 122 that the two BDP engines 120 have in common, if any. For any AOI 122 not represented in a copied transaction database, the new BDP engine 120 will have to generate a corresponding transaction-location list from scratch.

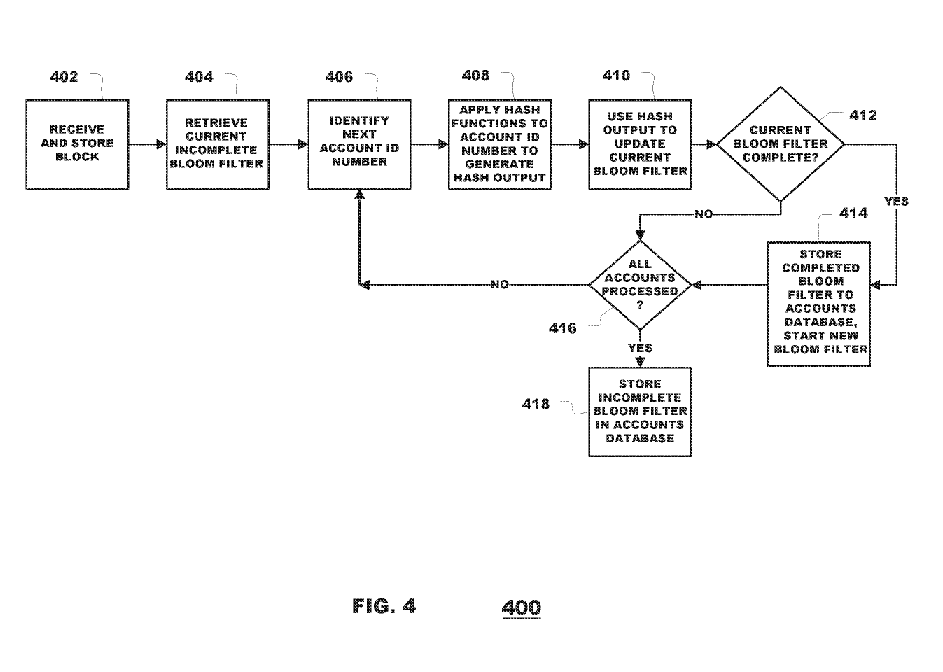

As described above, the BDP engine 120 processes each block 114 in the blockchain 110 at least once and possibly only once. During the first processing of a block 114, the BDP engine 120 notes the account address of the miner who won the block's reward. Each block 112 has a single winning miner. In addition, the BDP engine 120 updates the transaction-location database 150, the accounts database 160, and the blocks database 170, as appropriate. In particular, for each AOI 122 identified in the AOI database 130, the BDP engine 120 identifies any transactions for that AOI 122 contained in the block 114 and adds the locations for those transactions, if any, to the transaction-location list for that AOI 122 in the transaction-location database 150. In addition, the BDP engine 120 updates one or more bloom filters in the accounts database 160 to represent those accounts having data in the block 114. This processing is described in further detail below with reference to FIG. 4. Note that the BDP engine 120 includes the account of each block's winning miner in each corresponding bloom filter. In addition, if that account is an AOI 122, then the BDP engine 120 includes an address for the block in the transaction-location list for that AOI 122 in the transaction-location database 150. In addition, the BDP engine 120 may also convert the block 114 into an optimized, binary version 116 for storage in the blocks database 170. Note that, if the BDP engine 120 ever processes a block 114 for a second (or subsequent) time, the BDP engine 120 will not have to update the accounts database 160.

In certain implementations, for each transaction in the new block, the BDP engine 120 generates all of the traces for that transaction, uses those traces to (i) add tuples to the transaction-location lists in the transaction-location database 150 for any AOIs 122 that are involved in that transaction and (ii) update one or more bloom filters in the accounts database 160 for all accounts that are involved in that transaction, and then discards those traces. In this way, the BDP engine 120 can update both the transaction-location database 150 and the accounts database 160 without having to generate the traces for each transaction more than once.

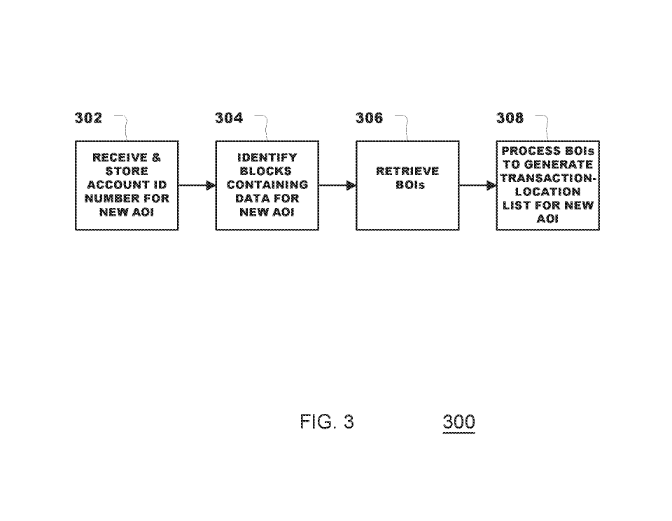

When the account ID number for a new account of interest 122 is received, the BDP engine 120 adds the account ID number for the new AOI to the AOI database 130 and accesses the accounts database 160 to identify the blocks in the blockchain 110 having data for that AOI. These identified blocks are referred to as blocks of interest (BOIs). The BDP engine 120 retrieves and processes each BOI either from the blocks database 170 or, if the BOI is not represented in the blocks database 170, from the blockchain 110 itself to generate a new tuple-based transaction-location list for the new AOI 122 for inclusion in the transaction-location database 150. If the BDP engine 110 retrieves a BOI from the blockchain 110, then the BDP engine 110 can store an optimized version of the BOI to the blocks database 170. This processing is described in further detail below with reference to FIG. 3. Because of the existence of the accounts database 160 and the blocks database 170, the BDP engine 120 is able to update the transaction-location database 150 significantly faster than if the BDP engine 120 were to have to search through the entire blockchain 110 for the new AOI 122 without the benefit of those databases. Moreover, as described further below, the accounts database 160 represents the accounts in the blockchain 110 in a memory-efficient manner that keeps the size of the accounts database 160 relatively small, despite the large and expanding size of the blockchain.

### Generation of Reports

Among many other functions, the BDP engine 120 is capable of generating reports 128 for one or more accounts of interest (AOIs) 122, which represent a subset of all of the different accounts having data in the Ethereum blockchain 110. The AOIs 122 may represent the accounts specific to one or more individuals and/or one or more businesses that have purchased the BDP engine 120 or BDP engine services. Depending on the particular implementation, the reports 128 may include account statements covering transactions covering specific periods (e.g., year-to-date, last year, last month, or last week, or custom start and end) or filtered to include certain subsets of transaction types (e.g., deposits, withdrawals, gas) or summaries (e.g., balance by account, balance by transaction type).

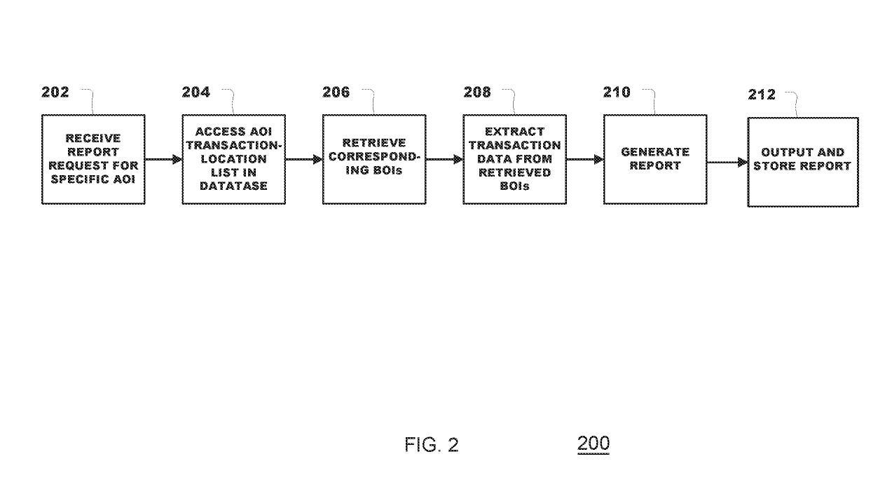

When a request 124 for a report for a specific AOI 122 is received, the BDP engine 120 accesses the transaction-location list for that AOI in the transaction-location database 150 to retrieve data for each listed transaction either from the blocks database 170 or, if the block containing the listed transaction is not represented in the blocks database 170, from the blockchain 110 itself and then generates the requested report 128 based on that retrieved data. If the data is to be retrieved from the blockchain 110 itself, then the BDP engine 120 uses the block ID number 126 from the transaction tuple to retrieve the corresponding block 114 from the blockchain 110. This processing is described in further detail below with reference to FIG. 2. Because of the existence of the transaction-location database 150 and the blocks database 170, the BDP engine 120 is able to generate reports 128 significantly faster than if the BDP engine were to search through the entire blockchain 110 for transactions without the benefit of those databases.

FIG. 2 is a flow diagram of the processing 200 performed by the BDP engine 120 to generate a report 128 for a specified AOI 122 in response to a received report request 124. The processing 200 begins in step 202 with the BDP engine 120 receiving the report request 124 for the specific AOI 122. In step 204, the BDP engine 120 uses the account ID number for the AOI 122 to access the corresponding tuple-based transaction-location list that is stored in the transaction-location database 150.

In step 206, for the locations identified in the transaction-location list, the BDP engine 120 uses the corresponding block ID numbers to retrieve the blocks of interest either from the blocks database 170 or, if a BOI is not represented in the blocks database 170, from the blockchain 110 itself. In step 208, the BDP engine 120 uses the tuples enumerated in the transaction-location list to access and extract the appropriate transaction data from the retrieved BOIs for the desired report. In step 210, the BDP engine 120 generates the desired report 128 using the extracted transaction data and, in step 212, the BDP engine 120 outputs and stores the report in the reports database 140. If, for example, the desired report 128 is a balance statement for the AOI 122, then the BDP engine 120 may generate a report with all the transactions, dates, and running balances for the AOI.

Note that the AOI 122 may have one or more transactions in each BOI retrieved in step 206. As such, the transaction-location list for the AOI 122 will have one or more corresponding tuples for each BOI, each tuple identifying the location of a different transaction in that BOI.

In one possible implementation of the processing 200 of FIG. 2, the BDP engine 120 sequentially retrieves one BOI at a time in step 206 and processes that BOI for the one or more tuples corresponding to transactions for the AOI 122 in that BOI in step 208 prior to retrieving and processing the next BOI in subsequent executions of steps 206 and 208. In another possible implementation, in step 206, the BDP engine 120 retrieves multiple BOIs (and possibly all of the BOIs that are referenced by the tuples in the transaction-location list accessed in step 204), and then processes those multiple BOIs in step 208. This latter implementation leaves open the possibility of steps 206 and 208 being implemented in parallel by multiple data-processing sub-engines. Note that this parallelism may create a bottleneck on the single blockchain resource and, in some cases, this bottleneck may be relieved by requesting these BOIs from multiple, independent copies of the blocks database 170 and/or from multiple, independent copies of the blockchain 110 in parallel. These independent copies may be accessed from distinct local and remote trusted nodes, from distinct trusted servers, from a high-performance raid-like service from a node with internal duplication of the blocks database and/or the blockchain for multiported non-contentious service of simultaneous block requests, or from a decentralized file system such as an implementation of an interplanetary file system (IPFS) or equivalent.

In one possible implementation, as the BDP engine 120 gathers the transaction data in step 208, the BDP engine 120 calculates a running balance for the AOI and compares that running balance to the running balances recorded in the blockchain 110. This processing provides a check on the operation of the BDP engine 120 and/or a check on the validity of the smart contract operations within the transactions in the blockchain 110.

In certain implementations, if the BDP engine 120 had previously generated and stored a report 128 for a particular AOI 122, then, when the BDP engine 120 subsequently receives a request 124 for another report for that same AOI 122, the BDP engine 120 can retrieve the previous report 128 from the reports database 140 and update that report using only the recent tuples in the transaction-location list in the transaction-location database 150 for that AOI 122 without having to re-create the entire report from scratch.

### Maintenance of the Transaction Database

Whenever a new block 112 gets added to the blockchain 110, the BDP engine 120 processes the new block 112 to update, as necessary, the transaction-location lists stored in the transaction-location database 150 for the AOIs 122 currently identified in the AOI database 130. This processing involves the BDP engine 120 identifying each transaction in the new block 112, determining whether the transaction involves one of the AOIs 122, and, if so, appending the tuple for that transaction to the end of the transaction-location list for that AOI in the transaction-location database 150.

When the BDP engine 120 receives the account ID number for a new AOI 122 to support, the BDP engine 120 updates the transaction-location database 150 to add a new list of transaction locations for the new AOI.

FIG. 3 is a flow diagram of the processing 300 performed by the BDP engine 120 to update the transaction-location database 150 when the account ID number for a new AOI 122 is received. The processing 300 begins in step 302 with the BDP engine 120 receiving and storing the account ID number for the new AOI 122 in the AOI database 130. In step 304, the BDP engine 120 uses the account ID number for the new AOI 122 to access the accounts database 160 to identify the block ID numbers for the blocks in the blockchain 110 that may contain data for the new AOI 122. In step 306, the BDP engine 120 uses the retrieved block ID numbers 126 to retrieve the blocks of interest either from the blocks database 170 or, if a BOI is not represented in the blocks database 170, from the blockchain 110 itself. In step 308, the BDP engine 120 processes the retrieved BOIs to identify transactions for the new AOI 122 contained in the BOIs and generate, for each transaction, a corresponding tuple to be included in the new transaction-location list for the new AOI 122 in the transaction-location database 150.

Note that one or more blocks in the blockchain 110 will contain data for the new AOI 122. In one possible implementation, the BDP engine 120 sequentially retrieves one BOI at a time in step 306 and processes that BOI in step 308 prior to retrieving and processing the next BOI in subsequent executions of steps 306 and 308. In another possible implementation, the BDP engine 120 first retrieves multiple BOIs (and possibly all of the BOIs) in step 306 and then processes those multiple BOIs in step 308. This latter implementation leaves open the possibility of steps 306 and 308 being implemented in parallel by multiple data-processing sub-engines. In such parallel implementations, the BOIs may be drawn from multiple, independent copies of the blocks database 170 and/or from multiple, independent copies of the block chain 110, as discussed previously, to minimize a bottleneck on a single blocks database and/or a single blockchain.

### Maintenance of the Accounts Database

In one possible implementation, the accounts database 160 could contain, for each account having data in the blockchain 110, a list explicitly identifying, by block ID number, each block in the blockchain 110 containing data for that account. The size of such a database would be on the same order of magnitude as the size of the blockchain 110 itself.

In an alternative, preferred embodiment, the accounts database 160 uses a space-efficient probabilistic data structure such as a bloom filter to represent the accounts in the blockchain 110. Bloom filters are described in Burton H. Bloom, “Space/Time Trade-offs in Hash Coding with Allowable Errors,” Communications of the ACM, 13 (7): 422-426 (1970), the teachings of which are incorporated herein by reference in their entirety.

In one possible implementation, the bloom filters in the accounts database 160 are based on the Sha256 hash function described in the Yellow Paper. According to this implementation, when applied to a specified 20-byte account ID number, the hash function generates a 2048-bit hash output value in which one, two, or three bits are set to 1, with the remaining bits all set to 0. The one, two, or three specific bits that are set to 1 are likely to be, but do not have to be, different for two different account ID numbers. A bloom filter for the accounts database 160 is generated by applying the hash function to a specified set of different account ID numbers and bitwise logically ORing the corresponding 2048-bit hash outputs together. The resulting 2048-bit bloom filter will have some of its bits set to 1 and the rest set to 0. Typically, larger sets of account ID numbers result in more bits of the bloom filter being set to 1.

To determine whether a particular account ID number might be a member of the set of account ID numbers used to generate a particular bloom filter, the same hash function is applied to the particular account ID number to generate a corresponding 2048-bit hash output having one, two, or three bits set to 1. The hash output is then bitwise ANDed with the bloom filter that represents the set of account ID numbers, and, if the result is non-zero, then the particular account ID number may be a member of the set of accounts ID numbers used to generate the bloom filter. If, however, the result is zero, then the account ID number is definitely not a member of the set of account ID numbers used to generate the bloom filter. Since the corresponding bit(s) in the bloom filter could have been set to 1 by applying the hash function to one or more different account ID numbers, the non-zero result of the bitwise ANDing could be a false positive indicating that the particular account ID number is a member of the set when, in fact, it is not. Thus, the bloom filter can generate true positive results and false positive results. Significantly, however, while the bloom filter can generate true negative results, the bloom filter cannot generate false negative results. Thus, the bloom filter will never wrongly indicate that a particular account ID number is not in the set when in fact it is.

In one possible implementation, the accounts database 160 could include one bloom filter for each block in the blockchain 110, where that single-block bloom filter could be used to provide an indication of whether or not any given account has data in that corresponding block. However, since the number of accounts can vary widely from block to block, such a non-adaptive scheme would be inefficient. In particular, single-block bloom filters for blocks containing data for relatively few accounts would be underutilized resulting in wasted bloom filter capacity. On the other hand, single-block bloom filters for blocks containing data for relatively many accounts could result in a high frequency of false positive outputs, which would result in inefficient processing 300 of FIG. 3 by the BDP engine 120 in generating the transaction-location list for a new AOI 122.

Instead of generating non-adaptive, single-block bloom filters, in a preferred implementation, the BDP engine 120 generates adaptive bloom filters for the accounts database 160, where each adaptive bloom filter has approximately the same target fullness level, where fullness is based on the number of bits in the bloom filter that are set to 1. The target fullness level can be selected to correspond to a maximum acceptable rate of false positive bloom filter results, which may be dependent on the amount of available resources on the target machine used to implement the BDP engine 120. To achieve this uniformity, the BDP engine 120 generates the accounts database 160 by initializing a first bloom filter to zero at the beginning of the first block in the blockchain 110. When the first bloom filter reaches the specified target fullness level, the BDP engine 120 stores the first bloom filter as the first completed bloom filter in the accounts database 160.

Depending on the number of different accounts having data in the beginning of the blockchain 110, the end of the first bloom filter may occur somewhere in the first block in the blockchain 110 or somewhere in a subsequent block in the blockchain 110. Either way, the beginning of the second bloom filter will correspond to the next transaction after the end of the first bloom filter. As described in further detail below in the context of FIG. 4, in general, a given bloom filter will begin with the next account encountered in the blockchain 110 after the last account represented in the previous bloom filter and will end when the target fullness level is reached in that given bloom filter. In some implementations, after reaching the target fullness level, the current transaction trace or even the current transaction is completed before completing the current bloom filter even if that means exceeding the target fullness level. Once the BDP engine 120 stores a completed bloom filter into the accounts database 160, that bloom filter is never modified. After storing a completed bloom filter, the BDP engine 120 immediately starts to generate the next bloom filter from where the just-completed bloom filter ended.

As such, the accounts database 160 contains a number of different bloom filters, each corresponding to a different, contiguous portion of the blockchain 110, where each bloom filter spans from a particular filter-start location in a particular block in the blockchain 110 to a particular filter-stop location in a particular block in the blockchain 110, where the start and stop locations may be in two different blocks or within the same block in the blockchain 110. Note that each 2048-bit bloom filter gets stored in the accounts database 160 along with at least the filter-stop location for that bloom filter. Note that the filter-start location for any bloom filter can be determined from the filter-stop location for the previous bloom filter in the accounts database 160.

When a particular account ID number is applied to a particular bloom filter in the accounts database 160, the bloom filter generates either a positive result or a negative result. Due to the absence of false negatives for bloom filters, a negative result indicates that the portion of the blockchain 110 represented by that bloom filter does not contain any data for the account identified by the particular account ID number. On the other hand, due to the possibility of false positives for bloom filters, a positive result indicates that the portion of the blockchain 110 represented by that bloom filter might or might not contain data for the identified account.

In such a bloom filter-based implementation of FIG. 1, step 304 of FIG. 3 involves the BDP engine 120 applying the hash function to the account ID number for the new AOI 122. The BDP engine 120 then compares the resulting 2048-bit hash output to the different 2048-bit bloom filters stored in the accounts database 160 to determine which portions of the blockchain 110 might have data for the new AOI 122. As described above, the BDP engine 120 can perform each comparison by determining whether the bitwise AND of the hash output and the particular bloom filter is non-zero. If the ANDing result is zero, then the comparison outcome is negative and the BDP engine 120 can ignore the portion of the blockchain 110 represented by that bloom filter. If the ANDing result is non-zero, then the comparison outcome is positive and, in step 306, the BDP engine 120 retrieves, from the blocks database 170 and/or from the blockchain 110, the one or more blocks corresponding to the portion of the blockchain 110 represented by that bloom filter. In step 308, the BDP engine 120 processes the one or more retrieved blocks (or at least the parts of those one or more retrieved blocks contained in the corresponding portion of the blockchain 110) to try to identify the locations of transactions for the new AOI 122 that are to be stored in the transaction-location database 150.

Note that, if a bloom filter generates a false positive result, then the BDP engine 120 will process the blocks in the corresponding portion of the blockchain 110 without finding any transactions for the new AOI 122. In that way, the false-positive bloom filter result will result in wasted processing, but the fact that bloom filters do not generate false negative results means that the BDP engine 120 will never miss any transactions for the new AOI 122.

Note that the presence of multiple bloom filters in the accounts database 160 opens up the possibility for further parallelism in the processing 300 of FIG. 3, where the hash output for the account ID number for the new AOI 122 is concurrently compared to the multiple bloom filters in parallel by multiple data-processing sub-engines.

To generate the accounts database 160, starting with the very first block in the blockchain 110, the BDP engine 120 sequentially processes each block in the blockchain 110 one time to generate bloom filters for the accounts database 160. Because new blocks 112 continue to be added to the blockchain 110, the BDP engine 120 updates the accounts database 160 every time a new block 112 is added.

FIG. 4 is a flow diagram of the processing 400 performed by the BDP engine 120 to update the accounts database 160 for a block 114 retrieved from the blockchain 110. The processing 400 is sequentially invoked one time for each block 114 in the blockchain 110. Since the ends of the bloom filters are not guaranteed to coincide with the ends of blocks, when the BDP engine 120 finishes processing the current block 114, the bloom filter that the BDP engine 120 was generating (aka the current bloom filter) will typically be incomplete (i.e., below the target fullness level). Nevertheless, since an incomplete current bloom filter can represent accounts having data in one or more blocks 114 in the blockchain 110, the incomplete current bloom filter should be stored in the accounts database 160 to be available for the processing 300 of FIG. 3 in order to generate an up-to-date transaction-location list for a new AOI 122. As such, when the BDP engine 120 finishes the processing 400 of FIG. 4 for the current block 114, the BDP engine 120 stores the current bloom filter in the accounts database 160 as an incomplete bloom filter for subsequent updating when the next block 114 is retrieved from the blockchain 110.

The processing 400 of FIG. 4 begins in step 402 with the BDP engine 120 the BDP engine 120 receiving and storing the block 114 in a local cache. In step 404, the BDP engine 120 retrieves from the accounts database 160 the incomplete current bloom filter that existed at the end of the processing 400 of the previous block 114. Alternatively, the BDP engine 120 can maintain a separate copy of the incomplete current bloom filter that is retrieved in step 404.

In step 406, the BDP engine 120 identifies the account ID number for the next account involved in a transaction in the block 114. As suggested previously, the BDP engine 120 can identify accounts by parsing the block 114 to identify each transaction in the block and, for each transaction, the BDP engine 120 can follow the trace of the transaction (i.e., for Ethereum blocks, the trace is followed potentially through nested levels of smart contracts and other calls) and extract the identities of any accounts for the transaction.

In particular, for each transaction, the BDP engine 120 notes the ‘from’ address, the ‘to’ address, the address (‘contractAddress’) representing any smart contracts created as a result of the transaction, and the addresses of accounts that generated events during that invocation of the transaction. All of this data may be generated by the BDP engine 120 at the start of the processing of the current block.

If the ‘to’ address for the current transaction is a smart contract, then the BDP engine 120 then further requests any traces generated by that transaction of which there may be many thousands. The BDP engine 120 then processes each trace. By following each transaction trace (which may represent “calls into” or “creation of” other smart contracts, which subsequently may “call into” or “create” yet more smart contracts), every account involved in a given transaction can be recorded. At each trace, which is similar in format to a top-level “external” transaction, the BDP engine 120 notes the ‘from’, ‘to’, ‘refundAddress’ (in the case of a smart contract suicide), ‘action.address’ in the case of a smart contract internal invocation (i.e., a ‘call’ or ‘delegatecall’), or ‘result.address’ (in the case of the creation of a new smart contract by the currently transacting contract).

If necessary, the BDP engine 120 furthermore uses the traces to identify in-error transactions. On the Ethereum blockchain 110, visiting a transaction's traces is the only way to accurately identify in-error transactions prior to the Byzantium fork. The Byzantium Fork was a 2017 upgrade to the Ethereum blockchain code that (among other things) corrected the fact that the only way to determine if a transaction ended in error, was to visit every trace of that transaction. The Byzantium Fork fixed this by noting the error status at the transaction receipt level as opposed to deep down in a trace. For all blocks prior to the Byzantium Fork, one still needs to look at traces to determine transaction error status. After the Byzantium fork, this is no longer necessary.

In step 408, the BDP engine 120 applies the hash function to the current account ID number to generate a corresponding 2048-bit hash output and, in step 410, the BDP engine 120 updates the current bloom filter by bitwise logically ORing that 2048-bit hash output with the 2048-bit value of the current bloom filter to generate an updated 2048-bit value for the current bloom filter. Note that, if there are multiple transactions in the BOI 114 for the same account, the corresponding account ID number will simply be repeatedly hashed to the same 2048-bit hash output, which will result in no change to the value of the current bloom filter.

In step 412, the BDP engine 120 compares the fullness of the updated current bloom filter to the specified target fullness level to determine if the current bloom filter is completed. One measure of the fullness of a bloom filter is calculated by summing across the bits of the bloom filter. This sum indicates the number of bits set to 1 in the bloom filter. In one possible implementation, a bloom filter is said to be completed when at least 200 of the bloom filter's 2048 bits are set to 1. Other implementations may use higher or lower target fullness levels. As described previously, a specific target fullness level represents a trade-off between bloom filter utilization, false positive rate, and resource (i.e., disc space) utilization. Higher target fullness levels represent greater bloom filter utilization at the cost of higher false positive rates but lower disc space usage.

If the BDP engine 120 determines, in step 412, that the fullness of the current bloom filter is less than the target fullness level, then the BDP engine 120 determines that the current bloom filter is not yet completed and processing proceeds to step 416, where the BDP engine 120 determines whether all of the account ID numbers for the transactions in the current block 114 have been processed. If not, then processing returns to step 406, where the BDP engine 120 identifies the next account ID number in the block 114 for updating the current bloom filter in steps 408 and 410. If, however, the BDP engine 120 instead determines, in step 416, that all of the account ID numbers have been processed, then, in step 418, the current bloom filter is stored in the accounts database 160 as an incomplete bloom filter to be retrieved and further updated when the BDP engine 120 processes the next block 114 in the blockchain 110.

If, in step 412, the BDP engine 120 determines that the fullness of the current bloom filter is greater than or equal to the target fullness level, then processing proceeds to step 414, where the BDP engine 120 stores the current bloom filter as a completed bloom filter in the accounts database 160 and initializes a new 2048-bit current bloom filter having all bits set to 0. Processing then proceeds to step 416 with the new current bloom filter. Note that, if the completion of the current bloom filter (as determined in step 412) coincides with the end of the current block 114 (as determined in step 416), then the incomplete current bloom filter stored in the accounts database 160 in step 418 will have all bits set to 0 as initialized in step 414. When the next block 114 is processed, the BDP engine 120 will simply retrieve that all-zero current bloom filter from the accounts database 160 and update it with new account information.

Note that, as described previously and depending on the particular implementation, when the target fullness level is reached, the BDP engine 120 may complete the current trace, the current transaction, or even the current block before determining that the current bloom filter is complete, even if that means slightly exceeding the target fullness level for the current bloom filter.

Using the processing 400 of FIG. 4, the BDP engine 120 processes each block 114 in the Ethereum blockchain 110 to generate the bloom filters of the accounts database 160. Although the size of the represented portion of the blockchain 110 varies from bloom filter to bloom filter, each 2048-bit bloom filter along with its corresponding filter-stop location is significantly smaller than an explicit listing of the 20-byte account ID numbers for the accounts having data in the same portion of the blockchain 110. As a result, the accounts database 160 will be orders of magnitude smaller than an explicit mapping index between accounts and blocks. This allows the BDP engine 120 to maintain its miniscule stance on consumer-grade hardware. Furthermore, the bloom filters enable the BDP engine 120 to generate the transaction-location list for a typical new AOI 122 for the transaction-location database 150 orders of magnitude faster than having to process the entire Ethereum blockchain 110 to locate the transactions for that new AOI 122. This is especially important for the potentially very long list of traces which must be accessed in order to build an accurate list of transactions.

### Maintenance of the Blocks Database

As described previously, the BDP engine 120 converts some and possibly all of the blocks 114 in the blockchain 110 into corresponding binary, optimized versions 116 for storage in the blocks database 170. Because the stored data is in a binary format (as opposed to the JavaScript Object Notation (JSON) format of the retrieved blockchain data), the BDP engine 120 can retrieve data from the blocks database 170 significantly faster than requesting the same data from the blockchain 110. Moreover, the optimized, binary versions 116 are significantly smaller than the corresponding blockchain blocks 114.

To convert a blockchain block 114 for storage in the blocks database 170, the BDP engine 120 removes unnecessary and/or uninteresting data such as the block's digital signature, its state, receipt, and transaction roots and other hashes, and the node-generated bloom filters (particularly those from the transaction receipts). (Note that these node-generated bloom filters are different from the bloom filters stored in the accounts database 160.) Note that the information in the node-generated bloom filters (and then some) is contained in the adaptive bloom filters stored in the accounts database 160. The node-generated bloom data is typically of no use to the accounting functions of the BDP engine 120, although the BDP engine 120 could be configured to retain that data for a particular use. In fact, retention of any of the above-mentioned discarded block data can be enabled optionally for particular uses. This ability to optionally store any part of the block data in the blocks database 170 is an additional feature of the BDP engine 120.

In addition, the BDP engine 120 pre-calculates useful data that may be needed in subsequent analysis, such as the size of the block file to be stored in the blocks database 170, the size and number of the enhanced, adaptive bloom filters in the accounts database 160 corresponding to the block, the number of traces encountered per transaction, etc. Because each block has a certain price in fiat currency at the time of its creation, the BDP engine 120 writes price information into the blocks database 170 as well. This removes the need to retrieve that information later.

After storing the optimized, binary version 116 in the blocks database 170, the BDP engine 120 deletes the JSON data of the retrieved blockchain block 114.

### Blockchain-Level Data Analysis

The previous discussion focused on the analysis of blockchain data for specified accounts of interest 122. To support that account-level data analysis, the BDP engine 120 maintains (i) the transaction-location database 150 to store the location in the blockchain 110 of each transaction for each specified AOI 122 as well as (ii) the blocks database 170 to store optimized, binary versions 116 of (at least) those blockchain blocks 114 containing those transactions. In order to support a newly specified AOI 122, the BDP engine 120 also maintains the accounts database 160 to store bloom filters that identify blockchain blocks 114 might contain data for each blockchain account, where BDP engine 120 uses the accounts database 160 to (i) generate a new transaction-location list to the transaction-location database 150 for the new AOI 122 and (ii) possibly add new optimized, binary blocks 116 to the blocks database 170.

As mentioned in the previous section, the BDP engine 120 can be configured to store, in the blocks database 170, an optimized, binary version 116 of each block 114 in the blockchain 110. In that case, the BDP engine 120 can be further configured to support data analysis at the entire blockchain level that can be faster than would be available by having to directly access the blockchain 110 itself. Depending on what specific data is stored in the blocks database 170, this blockchain-level data analysis can take into account blocks, transactions, receipts, logs, and/or traces. Such blockchain-level data analysis can extend to portions of the blockchain data larger than single contracts such as industry-wide segmentations of the data (to the extent it is possible to cleanly categorize such things) and to system-wide, all-inclusive analyses such as ‘gas’ usage, smart contract deployment costs, asset pricing, comparative usage analysis between multiple smart contracts, system monitoring, and per-block accounting/auditing.

As described previously, each bloom filter in the accounts database 160 represents a different portion of the blockchain 110, with each portion having a filter-start location and a filter-stop location. Since the completed bloom filters all have approximately the same fullness level, the length of the portion of the blockchain 110 corresponding to a particular bloom filter gives an indication of the density of the number of different accounts having data in that particular portion of the blockchain 110. This density information is an example of blockchain-level data that is available to the BDP engine 120.

### A Note on the Permanence of the Data

Due to the nature of all blockchains, blocks may be reverted in a process known as forking. Forking happens continually in a blockchain and results in the possible correction or reorganization of certain recent blocks. After a specified forking period (for example, six to eight minutes for the Ethereum blockchain 110), it is safe to assume that any block that is older than the forking period will never revert.

One way to handle the possibility of forking is to wait until a block is older than the forking period before the BDP engine 120 processes that block for the first time. Another way is to process the block and then, if it gets reverted during the forking period, re-process the block after the forking period ends. Note that, if a block gets re-processed, any subsequent blocks might also have to be re-processed (after their forking periods end), at least for the bloom filters in the accounts database 160.

### A Note on Sharding of the Data

One issue facing all blockchains is the issue of scaling to a global scale. One possible solution called “Sharding” proposes to “shard” (i.e., break up) a blockchain so that individual blockchain nodes are no longer required to hold the entire blockchain. Instead, each blockchain node will store only a shard (i.e., portion) of the entire blockchain. To handle such a situation, the BDP engine 120 can be configured to access different shards from different blockchain nodes to have access to the entire set of blockchain data.

### SUMMARY

To summarize, the blockchain data-processing engine 120 of FIG. 1 adaptively generates and stores bloom filters in the accounts database 160, where each bloom filter corresponds to a different portion of the Ethereum blockchain 110 and can be used to determine whether that portion of the blockchain 110 might contain data for any specified account of interest 122. The BDP engine 120 can also store optimized versions of blockchain blocks in the blocks database 170. The BDP engine 120 uses the bloom filters in the accounts database 160 and possibly blocks stored in the blocks database 170 to help generate a list of transaction locations to be stored in the transaction-location database 150 for new accounts of interest 122 to be supported by the BDP engine 120. The BDP engine 120 uses the transaction-location lists in the transaction-location database 150 to generate reports 128 for any of the AOIs 122 supported by the BDP engine 120 and/or to perform other meaningful tasks.

As each new block 112 gets added to the blockchain 110, the BDP engine 120 updates (i) the accounts database 160 for any accounts identified in the new block 112, (ii) the transaction-location database 150 for its supported AOIs, and (iii) possibly the blocks database 170. In particular, the BDP engine 120 uses the accounts having data in the new block 112 to update the incomplete, current bloom filter stored in the accounts database 160 using the processing 400 of FIG. 4. In addition, the BDP engine 120 uses the transactions in the new block 112 for AOIs 122 being monitored by the BDP engine 120 to update the transaction-location lists stored in the transaction-location database 150 for those AOIs. If there are persistent reports maintained for specific AOIs 122, the BDP engine 120 may store those reports 128 in a reports database 140 to be updated with any new transaction information and new balances for those AOIs 122. Furthermore, the BDP engine 120 can generate and store, in the blocks database, an optimized version of the new block 112.

FIG. 1 shows a blockchain data-processing system 100 with one BDP engine 120 processing data from one copy of the Ethereum blockchain 110. Those skilled in the art will understand that the BDP system 100 may have multiple (co-located and/or distributed) instances of the BDP engine 120 processing data from the same copy of the Ethereum blockchain 110 or from multiple, independent copies of the Ethereum blockchain 110, where each BDP engine 120 monitors a (potentially) different set of one or more AOIs 122. Moreover, the BDP system 100 could be part of a BDP network having multiple (co-located and/or distributed) instances of the BDP system 100 of FIG. 1, each BDP system having one or more instances of the BDP engine 120 processing data from one or more different, identical copies of the Ethereum blockchain 110.

Since the bloom filters in the accounts database 160 characterize all of the accounts in the entire Ethereum blockchain 110, in theory, the different copies of the accounts database 160 for the different instances of the BDP engine 120 in such a blockchain-processing network could all be identical. As such, the multiple, identical instances of the accounts database 160 in that blockchain-processing network could be subject to consensus rules that are analogous to the consensus rules for the different instances of the Ethereum blockchain 110 itself throughout the Ethereum network. The accounts database 160 may be encrypted and distributed via a decentralized file system such as the interplanetary file system or distributed via a smart contract in the blockchain 110. In one possible implementation, as each new block 114 is received, the BDP engine 120 checks for the existence of a smart contract containing a relatively up-to-date accounts database 160 and, if none is found, the BDP engine 120 can insert the accounts database 160 into the blockchain 110 itself. In fact, the code for the BDP engine 120 can also be embedded in the blockchain 110 and distributed and updated to subscribers via the blockchain itself, with subscription fees being transacted and documented in the blockchain.

Although the invention has been described in the context of bloom filters having a hash function that generates a 2048-bit hash output having one, two, or three bits set to 1, those skilled in the art will understand that other suitable bloom filters can be used having different hash functions, different size hash outputs, and/or a maximum number of bits set to 1 being greater or smaller than three. Furthermore, suitable space-efficient probabilistic data structures other than bloom filters can also be used, as long as they do not produce false negative results.

Although the invention has been described in the context of the Ethereum blockchain, those skilled in the art will understand that the present invention can also be implemented in the context of blockchains other than the Ethereum blockchain including (but not limited to) Ethereum-based blockchains that are derived from or modified versions of the Ethereum blockchain. Note that, as used herein, the term “Ethereum-based blockchains” includes the Ethereum blockchain.

In certain embodiments, the invention is a blockchain data-processing (BDP) system for processing a blockchain having blockchain blocks. The system comprising a BDP engine configured to process the blockchain blocks and an accounts database distinct from the blockchain and configured to cover all accounts having data in the blockchain. When the BDP engine receives a blockchain block, the BDP engine identifies each account having data in the blockchain block and updates the accounts database for each identified account. The BDP engine is configured to access the accounts database to identify portions of the blockchain having data for any specified account.

In certain embodiments of the foregoing, the blockchain is stored in a blockchain node of a blockchain network comprising a plurality of blockchain nodes storing identical copies of the blockchain. The BDP system is one of a plurality of instances of the BDP system, each instance configured to process blockchain blocks in a corresponding copy of the blockchain stored in a corresponding blockchain node of the blockchain network. Each instance of the BDP system comprises a corresponding instance of the BDP engine that generates and maintains a corresponding instance of the accounts database.

In certain embodiments of the foregoing, the plurality of instances of the accounts database are identical.

In certain embodiments of the foregoing, the BDP system further comprises a transaction-location database configured to be used by the BDP engine to identify locations of transactions in the blockchain for one or more specified accounts of interest (AOIs). The BDP engine is configured to access the accounts database to identify the portions of the blockchain having data for a specified AOI; analyze the identified portions of the blockchain to identify locations of transactions involving the specified AOI; and store a list of the identified transaction locations for the specified AOI in the transaction-location database.

In certain embodiments of the foregoing, the accounts database comprises a plurality of bloom filters, each bloom filter covering accounts having data in a corresponding portion of the blockchain. The BDP engine is configured to access any bloom filter in the accounts database to determine whether the corresponding portion of the blockchain has data for a specified account. The BDP engine is configured to process a blockchain block to update one or more bloom filters in the accounts database.

In certain embodiments of the foregoing, the BDP engine is configured to receive a blockchain block and identify each account having data in the blockchain block. For each identified account, the BDP engine is configured to update a current bloom filter for the identified account; determine whether the current bloom filter is to be completed; and start a new bloom filter after the current bloom filter has been completed.

In certain embodiments of the foregoing, the BDP engine is configured to determine that the current bloom filter is to be completed when the BDP engine determines that the current bloom filter has reached a target fullness level that represents a threshold number of bits in the current bloom filter that are set.

In certain embodiments of the foregoing, the BDP engine is configured to complete processing of a current transaction or trace in the blockchain block before completing the current bloom filter.

In certain embodiments of the foregoing, all completed bloom filters in the accounts database have approximately equal fullness levels.

In certain embodiments of the foregoing, completed bloom filters in the accounts database are not required to start at the beginning of a blockchain block and are not required to stop at the end of a blockchain block.

In certain embodiments of the foregoing, the blockchain is an Ethereum-based blockchain.

In certain embodiments, the invention is a BDP system for processing a blockchain having blockchain blocks. The system comprises a BDP engine configured to process the blockchain blocks and a transaction-location database distinct from the blockchain and configured to identify locations of transactions in the blockchain for one or more accounts of interest (AOIs). When a new AOI is specified, the BDP engine identifies portions of the blockchain having data for the new AOI; analyzes the identified portions of the blockchain to identify locations of transactions involving the new AOI; and stores a list of the identified transaction locations for the new AOI in the transaction-location database. The BDP engine is configured to access the transaction-location database to identify transaction locations in the blockchain for any of the one or more AOIs.

In certain embodiments of the foregoing, the blockchain is stored in a blockchain node of a blockchain network comprising a plurality of blockchain nodes storing identical copies of the blockchain. The BDP system is one of a plurality of instances of the BDP system, each instance configured to process blockchain blocks in a corresponding copy of the blockchain stored in a corresponding blockchain node of the blockchain network. Each instance of the BDP system comprises a corresponding instance of the BDP engine that generates and maintains a corresponding instance of the transaction-location database.

In certain embodiments of the foregoing, the plurality of instances of the transaction-location database are identical.

In certain embodiments of the foregoing, the BDP system further comprises a blocks database configured to store a binary block for each of one or more blockchain blocks. The BDP engine is configured to access the transaction-location database to identify transaction locations in the blockchain for a specified AOI. For each identified transaction location, the BDP engine is configured to access the blocks database to retrieve data for the specified AOI if the transaction location corresponds to one of the binary blocks in the blocks database; and access the blockchain to retrieve data for the specified AOI if the transaction location does not correspond to one of the binary blocks in the blocks database.

In certain embodiments of the foregoing, each transaction location in the transaction-location database is identified by (i) a first value identifying a corresponding blockchain block and (ii) a second value identifying a corresponding location within the corresponding blockchain block.

In certain embodiments of the foregoing, at least one transaction location in the transaction-location database is further identified by a third value identifying an index into a corresponding trace.

In certain embodiments of the foregoing, the blockchain is an Ethereum-based blockchain.

In certain embodiments, the invention is a BDP system for processing a blockchain having blockchain blocks. The system comprises a BDP engine configured to process the blockchain blocks and a blocks database distinct from the blockchain and configured to contain one or more binary blocks corresponding to one or more blockchain blocks. The BDP engine is configured to convert the one or more blockchain blocks into the one or more binary blocks for storage in the blocks database. The BDP engine is configured to access the blocks database to retrieve data stored in any of the binary blocks.

In certain embodiments of the foregoing, the blockchain is stored in a blockchain node of a blockchain network comprising a plurality of blockchain nodes storing identical copies of the blockchain. The BDP system is one of a plurality of instances of the BDP system, each instance configured to process blockchain blocks in a corresponding copy of the blockchain stored in a corresponding blockchain node of the blockchain network. Each instance of the BDP system comprises a corresponding instance of the BDP engine that generates and maintains a corresponding instance of the blocks database.

In certain embodiments of the foregoing, the plurality of instances of the blocks database are identical.

In certain embodiments of the foregoing, the BDP engine is configured to convert each blockchain block into a corresponding binary block for storage in the blocks database.

In certain embodiments of the foregoing, the BDP system further comprises a transaction-location database configured to store locations of transactions in the blockchain for one or more accounts of interest (AOIs). The BDP engine is configured to convert a blockchain block into a corresponding binary block for storage in the blocks database only if the blockchain block has data for at least one AOI.

In certain embodiments of the foregoing, the blockchain is an Ethereum-based blockchain.

Embodiments of the invention may be implemented as (analog, digital, or a hybrid of both analog and digital) circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, general-purpose computer, or other processor.

Functional modules or units may be composed of circuitry, where such circuitry may be fixed function, configurable under program control or under other configuration information, or some combination thereof. Functional modules themselves thus may be described by the functions that they perform, to helpfully abstract how some of the constituent portions of such functions may be implemented. In some situations, circuitry, units, and/or functional modules may be described partially in functional terms, and partially in structural terms. In some situations, the structural portion of such a description may be described in terms of a configuration applied to circuitry or to functional modules, or both.

Embodiments according to the disclosure include non-transitory machine-readable media that store configuration data or instructions for causing a machine to execute, or for configuring a machine to execute, or for describing circuitry or machine structures (e.g., layout) that can execute or otherwise perform, a set of actions or accomplish a stated function, according to the disclosure. Such data can be according to hardware description languages, such as HDL or VHDL, in Register Transfer Language (RTL), or layout formats, such as GDSII, for example.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.”

Embodiments of the invention can be manifest in the form of methods and apparatuses for practicing those methods. Embodiments of the invention can also be manifest in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the invention. Embodiments of the invention can also be manifest in the form of program code, for example, stored in a non-transitory machine-readable storage medium including being loaded into and/or executed by a machine, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

Any suitable processor-usable/readable or computer-usable/readable storage medium may be utilized. The storage medium may be (without limitation) an electronic, magnetic, optical, electromagnetic, infrared, or semiconductor system, apparatus, or device. A more-specific, non-exhaustive list of possible storage media include a magnetic tape, a portable computer diskette, a hard disk, a random access memory (RAM), a read-only memory (ROM), an erasable programmable read-only memory (EPROM) or Flash memory, a portable compact disc read-only memory (CD-ROM), an optical storage device, and a magnetic storage device. Note that the storage medium could even be paper or another suitable medium upon which the program is printed, since the program can be electronically captured via, for instance, optical scanning of the printing, then compiled, interpreted, or otherwise processed in a suitable manner including but not limited to optical character recognition, if necessary, and then stored in a processor or computer memory. In the context of this disclosure, a suitable storage medium may be any medium that can contain or store a program for use by or in connection with an instruction execution system, apparatus, or device.

The functions of the various elements shown in the figures, including any functional blocks labeled as “engines,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “engine” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

1. A blockchain data-processing (BDP) system (e.g., 100) for processing a blockchain (e.g., 110) having blockchain blocks (e.g., 114), the system comprising:
a BDP engine (e.g., 120) configured to process the blockchain blocks; and
an accounts database (e.g., 160) distinct from the blockchain and configured to represent all accounts having data in the blockchain, wherein:
the accounts database comprises one or more probabilistic data structures;
when the BDP engine receives a blockchain block, the BDP engine identifies each account having data in the blockchain block and updates at least one probabilistic data structure in the accounts database for each identified account; and
the BDP engine is configured to access one or more probabilistic data structures in the accounts database to identify portions of the blockchain having data for any specified account without a possibility of any false negative results, but with the possibility of false positive results.

2. The BDP system of claim 1, wherein:
the blockchain is stored in a blockchain node of a blockchain network comprising a plurality of blockchain nodes storing identical copies of the blockchain;
the BDP system is one of a plurality of instances of the BDP system, each instance configured to process blockchain blocks in a corresponding copy of the blockchain stored in a corresponding blockchain node of the blockchain network; and
each instance of the BDP system comprises a corresponding instance of the BDP engine that generates and maintains a corresponding instance of the accounts database.

3. The BDP system of claim 2, wherein the plurality of instances of the accounts database are identical.

4. The BDP system of claim 1, further comprising a transaction-location database (e.g., 150) configured to be used by the BDP engine to identify locations of transactions in the blockchain for one or more specified accounts of interest (AOIs), wherein the BDP engine is configured to:
access the accounts database to identify the portions of the blockchain having data for a specified AOI;
analyze the identified portions of the blockchain to identify locations of transactions involving the specified AOI; and
store a list of the identified transaction locations for the specified AOI in the transaction-location database.

5. The BDP system of claim 1, wherein:
the accounts database comprises a plurality of bloom filters, each bloom filter is a probabilistic data structure representing accounts having data in a corresponding portion of the blockchain;
the BDP engine is configured to access any bloom filter in the accounts database to determine whether the corresponding portion of the blockchain has data for a specified account; and
the BDP engine is configured to process a blockchain block to update one or more bloom filters in the accounts database.

6. The BDP system of claim 5, wherein the BDP engine is configured to:
receive a blockchain block;
identify each account having data in the blockchain block; and
for each identified account, the BDP engine is configured to:
update a current bloom filter for the identified account;
determine whether the current bloom filter is to be completed; and
start a new bloom filter after the current bloom filter has been completed.

7. The BDP system of claim 6, wherein the BDP engine is configured to determine that the current bloom filter is to be completed when the BDP engine determines that the current bloom filter has reached a target fullness level that represents a threshold number of bits in the current bloom filter that are set.

8. The BDP system of claim 7, wherein the BDP engine is configured to complete processing of a current transaction or trace in the blockchain block before completing the current bloom filter.

9. The BDP system of claim 5, wherein all completed bloom filters in the accounts database have approximately equal fullness levels.

10. The BDP system of claim 5, wherein completed bloom filters in the accounts database are not required to start at the beginning of a blockchain block and are not required to stop at the end of a blockchain block.

11. The BDP system of claim 1, wherein the blockchain is an Ethereum-based blockchain.

12. The BDP system of claim 1, further comprising a transaction-location database (e.g., 150) configured to be used by the BDP engine to identify locations of transactions in the blockchain for one or more specified accounts of interest (AOIs), wherein:
the BDP engine is configured to:
access the accounts database to identify the portions of the blockchain having data for a specified AOI;
analyze the identified portions of the blockchain to identify locations of transactions involving the specified AOI; and
store a list of the identified transaction locations for the specified AOI in the transaction-location database;
the accounts database comprises a plurality of bloom filters, each bloom filter is a probabilistic data structure representing accounts having data in a corresponding portion of the blockchain;
the BDP engine is configured to access any bloom filter in the accounts database to determine whether the corresponding portion of the blockchain has data for a specified account;
the BDP engine is configured to process a blockchain block to update one or more bloom filters in the accounts database;
the BDP engine is configured to:
receive a blockchain block;
identify each account having data in the blockchain block; and
for each identified account, the BDP engine is configured to:
update a current bloom filter for the identified account;
determine whether the current bloom filter is to be completed; and
start a new bloom filter after the current bloom filter has been completed;
the BDP engine is configured to determine that the current bloom filter is to be completed when the BDP engine determines that the current bloom filter has reached a target fullness level that represents a threshold number of bits in the current bloom filter that are set;
the BDP engine is configured to complete processing of a current transaction or trace in the blockchain block before completing the current bloom filter;
all completed bloom filters in the accounts database have approximately equal fullness levels;
completed bloom filters in the accounts database are not required to start at the beginning of a blockchain block and are not required to stop at the end of a blockchain block; and
the blockchain is an Ethereum-based blockchain.

13. The BDP system of claim 21, wherein:
when a new AOI is specified:
the BDP engine identifies portions of the blockchain having data for the new AOI;
if the BDP engine determines that a blockchain block in an identified portion of the blockchain is already represented by a converted, binary block in the blocks database, then the BDP engine analyzes the converted, binary block to identify any locations of transactions involving the new AOI;
if the BDP engine determines that a blockchain block in an identified portion of the blockchain is not already represented by a converted, binary block in the blocks database, then the BDP engine converts the blockchain block into a binary block for storage in the blocks database and analyzes either the blockchain block or the converted, binary block to identify any locations of transactions involving the new AOI; and
the BDP engine stores a list of the identified transaction locations for the new AOI in the transaction-location database; and
the BDP engine is configured to access the transaction-location database to identify transaction locations in the blockchain for any of the one or more AOIs.

14. The BDP system of claim 21, wherein:
the blockchain is stored in a blockchain node of a blockchain network comprising a plurality of blockchain nodes storing identical copies of the blockchain;
the BDP system is one of a plurality of instances of the BDP system, each instance configured to process blockchain blocks in a corresponding copy of the blockchain stored in a corresponding blockchain node of the blockchain network; and
each instance of the BDP system comprises a corresponding instance of the BDP engine that generates and maintains a corresponding instance of the transaction-location database and a corresponding instance of the blocks database.

15. The BDP system of claim 14, wherein the plurality of instances of the transaction-location database are identical and the plurality of instances of the blocks database are identical.

16. The BDP system of claim 21, wherein, for each identified transaction location, the BDP engine is configured to:
access the blocks database to retrieve data for the specified AOI if the transaction location corresponds to one of the binary blocks in the blocks database; and
access the blockchain to retrieve data for the specified AOI if the transaction location does not correspond to one of the binary blocks in the blocks database.

17. The BDP system of claim 21, wherein each transaction location in the transaction-location database is identified by:
(i) a first value identifying a corresponding blockchain block; and
(ii) a second value identifying a corresponding location within the corresponding blockchain block.

18. The BDP system of claim 17, wherein at least one transaction location in the transaction-location database is further identified by a third value identifying an index into a corresponding trace.

19. The BDP system of claim 21, wherein the blockchain is an Ethereum-based blockchain.

20. The BDP system of claim 13, wherein:
the BDP engine is configured to:
access the transaction-location database to identify transaction locations in the blockchain for a specified AOI; and
for each identified transaction location, the BDP engine is configured to:
access the blocks database to retrieve data for the specified AOI if the transaction location corresponds to one of the binary blocks in the blocks database; and
access the blockchain to retrieve data for the specified AOI if the transaction location does not correspond to one of the binary blocks in the blocks database;
each transaction location in the transaction-location database is identified by:
(i) a first value identifying a corresponding blockchain block; and
(ii) a second value identifying a corresponding location within the corresponding blockchain block; and
the blockchain is an Ethereum-based blockchain.

21. A BDP system (e.g., 100) for processing a blockchain (e.g., 110) having blockchain blocks (e.g., 114), the system comprising:
a BDP engine (e.g., 120) configured to process the blockchain blocks;
a blocks database (e.g., 170) distinct from the blockchain and configured to contain one or more binary blocks corresponding to one or more blockchain blocks, wherein the BDP engine is configured to access the blocks database to retrieve data stored in any of the binary blocks; and
a transaction-location database (e.g., 150) configured to store locations of transactions in the blockchain for one or more accounts of interest (AOIs), wherein, if the BDP engine determines that a blockchain block has data for at least one AOI, then the BDP engine ensures that a converted, binary block corresponding to the blockchain block is stored in the blocks database.

22-27. (canceled)
